(19) United States
(12) Patent Application Publication
(10) Pub. No.: US 2012/0105531 A1
(43) Pub. Date: May 3, 2012

(54) PRINTER

(76) Inventors: Jaime Marie Gilbert, Vancouver, WA (US); Wesley R. Schalk, Vancouver, WA (US); Pierre J. Kaiser, Vancouver, WA (US)

(21) Appl. No.: 12/913,472

(22) Filed: Oct. 27, 2010

(51) Int. Cl. B41J 29/38; B41J 2/01

(52) U.S. Cl. 347/16; 347/104

(57) ABSTRACT

A printer includes a printing device configured to print a recording medium, and a transport configured to move the recording medium to an entry of the duplexer path immediately after printing a first side of the recording medium such that an edge of the recording medium is contained by the entry of the duplexer path, and to hold the recording medium at the entry of the duplexer path before printing a second side of the recording medium.

### BACKGROUND

Printing on both surfaces or sides of a recording medium, like a sheet of paper (also referred to as duplex printing a sheet of paper), may be desired by a user of a printer for various reasons. For example the user wants to save resources, such as the paper, or he wants to prepare double sided printouts for brochures or presentations. When preparing brochures or presentations printing across the entire length or across the entire width and the entire length of the sheet on both sides (also referred to full bleed duplex printing) may be desired.

### DESCRIPTION OF THE DRAWINGS

FIG. 1 shows a schematic representation of a printer in accordance with embodiments for processing a recording medium, like a sheet of paper, for printing on both sides thereof, wherein a first part of a sheet has passed the printhead.

FIG. 2 shows the printer of FIG. 1 with more than half of a sheet printed by the printhead.

FIG. 3 shows the printer of FIG. 1 printing the entire length of the sheet or at least a part of the lower margin on the sheet.

FIG. 4 shows the printer of FIG. 1 with the sheet moved to an entry of the duplexer path immediately after printing the first side of the sheet in FIGS. 1-3.

FIG. 5 shows an enlarged view of the entry of the duplexer path shown in FIG. 4 with the sheet moved such that the trailing edge thereof is at a position close to the entry of the duplexer.

FIG. 6 shows an enlarged view of the entry of the duplexer path shown in FIG. 4 with the trailing edge curled in a direction away from the platen.

FIG. 7 shows an enlarged view of the entry of the duplexer path shown in FIG. 4 with the sheet stopped at a position having a larger distance between the edge and the roller pair and the resulting curl or movement of the edge out of the transport plane.

FIG. 8 shows the printer of FIG. 1 with the sheet moved into the duplexer path.

FIG. 9 shows the printer of FIG. 1 with the sheet moved back to the printhead.

FIG. 10 shows the printer of FIG. 1 with both sides of the sheet printed.

FIG. 11 is a schematic representation of a part a printer in accordance with another example, wherein FIG. 11(a) is a schematic representation of a part of the paper path of the printer, FIG. 11(b) is an enlarged side view of the entry of the duplexer path of the printer, FIG. 11(c) shows a top view of the platen of the printer, FIG. 11(d) illustrates the effects of a curl of the side edges of the sheet on the platen, and FIG. 11(e) illustrates how disadvantageous effects of the curl of the side edges of the sheet are avoided in accordance with embodiments.

FIG. 12 is a flow diagram of a method for printing.

FIG. 13 shows an example of a printer.

### DETAILED DESCRIPTION

In order to accomplish printing across the entire length of a recording medium or across the entire width and the entire length of the recording medium on both sides (also referred to as true full bleed duplex printing), a trailing edge of the recording medium on the first side will be printed. When being printed the trailing edge of the recording medium will not be held by a transport, for example by a feed pinch of two transport rollers. After printing the first side the transport direction of the recording medium is reversed to feed the trailing edge back into the feed pinch to allow a transport of the recording medium into a duplexer. If the recording medium is reversed back too quickly to print on its second side, there will be issues with smear and roller markings as the print material did not sufficiently dry upon entering into the transport of the duplexer path. However, when leaving the recording medium to dry in the print zone the bottom edge or trailing edge of the recording medium may curl so that it may not be properly fed into the feed pinch which may cause a jam.

A printer according to an embodiment comprises a printing device configured to print a recording medium, and a transport configured to move the recording medium to an entry of a duplexer path immediately after printing a first side of the recording medium such that an edge of a recording medium is contained by the entry of the duplexer path, and to hold the recording medium at the entry of the duplexer path before printing a second side of the recording medium.

To avoid the above situation the printed recording medium is immediately reversed after printing just enough so that an edge of the recording medium is contained by transport elements of a duplexer path, for example an upper paper guide paddle and a feed roller. This allows the recording medium to dry for an appropriate amount of time while controlling the behavior of the edge, now being the leading edge due to the reversed transport direction without effecting the print quality.

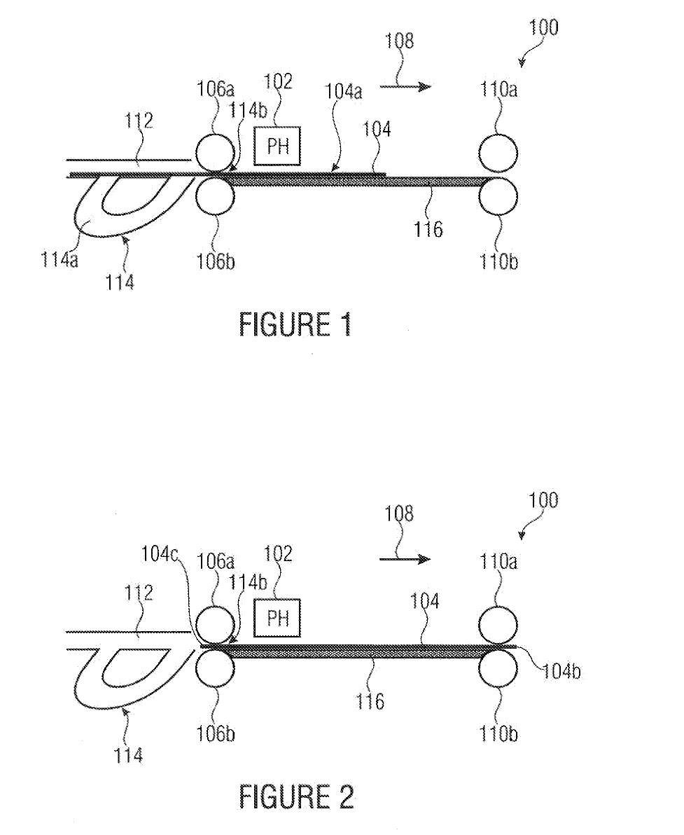

FIGS. 1 to 10 show schematic representations of a printer processing a recording medium, like a sheet of paper, for printing on both sides thereof.

FIG. 1 shows the printer 100 which includes a printhead 102 for applying a recording material, such as ink, to a sheet of paper 104. The printer 100 also has a transport including a first roller pair 106a, 106b provided in a transport direction 108 upstream of the printhead 102, and a second roller pair 110a, 110b provided downstream of the printhead 102. The printer 100 has an input path 112 for receiving the sheet of paper 104, for example, from a sheet magazine. Further, the printer 100 comprises a duplexer 114 having a duplexer path 114a. In the example shown in FIG. 1, an entry 114b of the duplexer 114 is formed by the roller pair 106a and 106b. The roller pair 106a and 106b feeds the sheet 104 along the input path 112 in the transport direction 108. When duplex printing is desired the roller pair 106a and 106b feeds the sheet 104 in a reverse direction and into the duplexer path 114a. A switching element may be provided in the input path 112 for guiding the sheet that is reversed into the duplexer path 114a. FIG. 1 shows the printer 100 that received the sheet 104 via the input path 112 and which is moved into the transport direction 108 by the transport rollers 106a and 106b. As the sheet 104 passes over the platen 116 and below the printhead 102 ink is applied in accordance with a desired pattern on a first side 104a of the sheet 104. The printhead 102 may be a stationary printhead having a width corresponding to the width of the sheet 104. Alternatively, the printhead 102 may be mounted to a carriage and may be moved in a widthwise direction reciprocally with regard to the sheet 104 for applying the ink. In FIG. 1 a first part of the sheet along the transport direction 108 already passed the printhead 102.

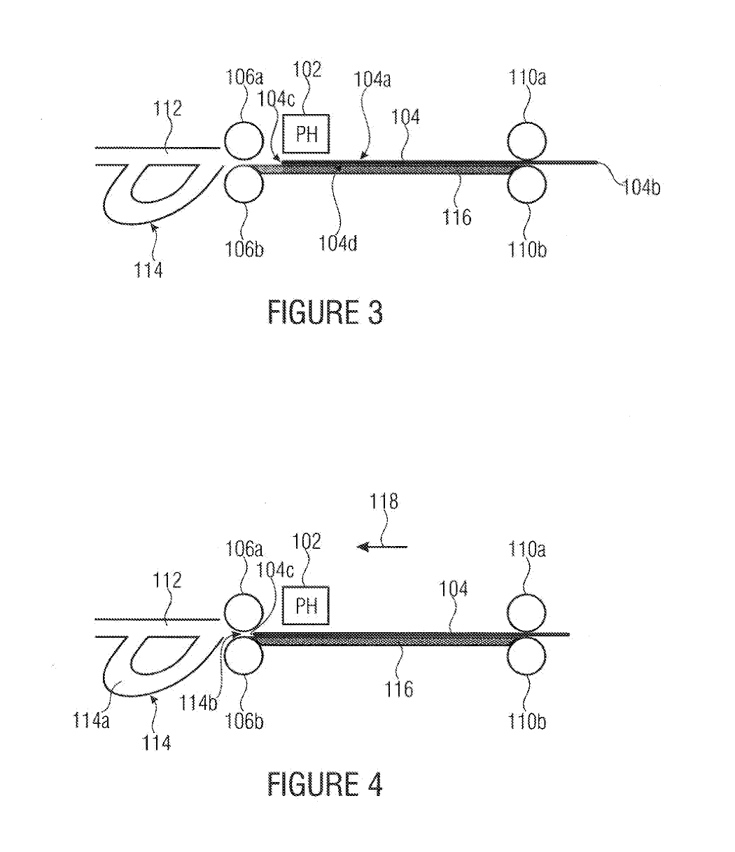

FIG. 2 shows that more than half of the sheet 104 was printed by the printhead 102. The leading edge 104b of the sheet 104 is within the feed pinch between the rollers 110a and 110b so that the sheet 104 can be further transported in the direction 108. The printhead 102 is shown schematically and may be positioned for printing on the first side 104a of the sheet 104 within a predefined print area. In case the predefined print area includes a lower margin, this may allow the trailing edge 104c of the sheet 104 to remain in the nip between the transport rollers 106a and 106b. If duplex printing is desired, the transport rollers 106a and 106b are simply reversed with the trailing edge 104c of the sheet 104 therebetween. In case it is desired to print the entire length of the sheet 104 or at least a part of the lower margin on the sheet the trailing edge is provided to the printhead, as is shown in FIG. 3. The sheet 104 is transported in the transport direction 108 such that the trailing edge 104c leaves the nip between the rollers 106a and 106b to allow printing on the lower edge or the bottom of the first side 104a of the sheet 104. When duplex printing is desired, the sheet transport direction is reversed so that the sheet 104 can be guided through the duplexer 114 for presenting a second side 104d of the sheet 104 to the printhead 102 for printing. The printed sheet 104 needs to dry prior to “re-entering” the trailing edge 104c into the feed pinch or nip between the rollers 106a and 106b to avoid smear or roller markings. However, the printed sheet 104 cannot remain in a position as shown in FIG. 3, i.e., can be left to dry in the print zone or on the platen 116 as the drying process may result in a curl so that upon feeding back the sheet 104 into the nip between the rollers 106a and 106b a jam may occur.

Therefore, in accordance with embodiments the sheet 104 is moved in a reverse direction 118 to the entry 114b of the duplexer 114 immediately after printing, as is shown in FIG. 4. Moving the sheet immediately after printing may include moving the sheet to the entry of the duplexer after printing the sheet is completed, for example after printing the trailing edge 104c thereof, and prior to the ink on the sheet 104 having dried. In accordance with another embodiment, moving the sheet immediately after printing may include moving the sheet 104 to the entry of the duplexer after a last swath of the ink was applied to the sheet 104. In accordance with yet another embodiment, moving the sheet immediately after printing may include moving the sheet to the entry of the duplexer after a predetermined or predefined period of time has elapsed after printing of the sheet was completed. The period of time may be between 0.1 and 1 seconds.

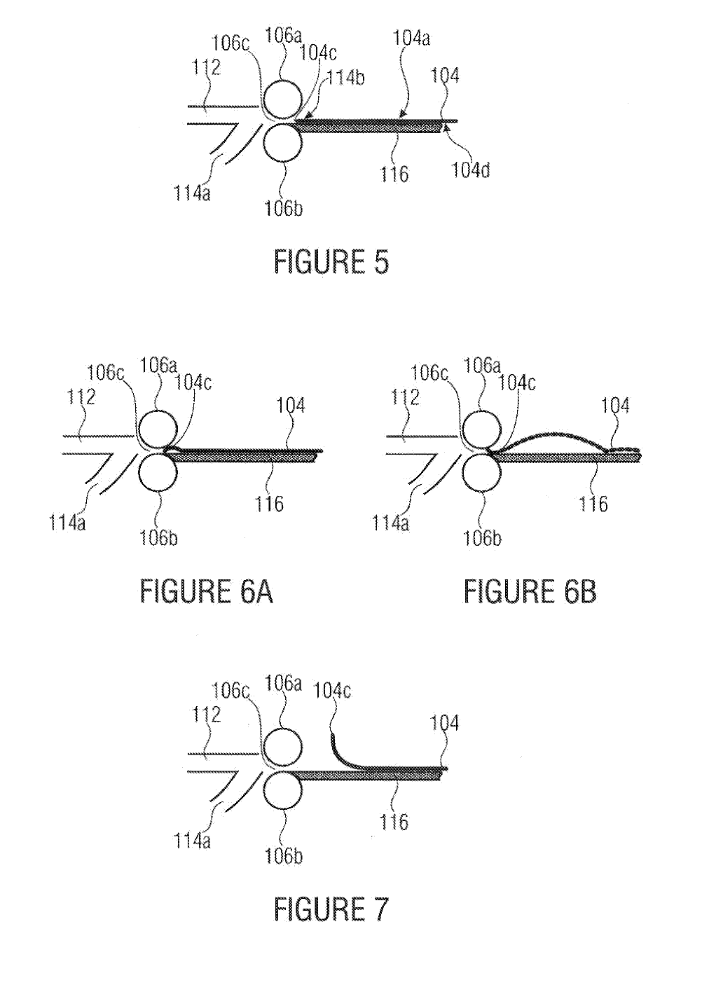

FIGS. 5 to 7 show enlarged views of the entry of the duplexer path shown in FIG. 4. For clarity reasons, the printhead is not shown in these figures. FIG. 5 shows the sheet 104 that was moved (e.g. by the transport rollers 110a and 110b) such that the trailing edge 104c thereof is at a position close to the entry 114b of the duplexer 114. The entry is formed by the two rollers 106a and 106b that define there between a feed pinch or nip 106c. FIG. 5 shows no curl or the like of the edge so that the sheet 104 is within its transport plane that is defined to be parallel to the platen 116. The sheet 104 is provided at this position immediately after printing and is held in this position to allow the ink that was applied to the first side 104a of the sheet 104 to dry. Possible curl of the trailing edge 104c is not an issue due to the position of the trailing edge close to the entry of the duplex path. FIG. 6A shows a trailing edge 104c curled in a direction away from the platen 116. Due the position of the trailing edge with respect to the entry 114b of the duplexer 114, the movement of the edge 104c of the sheet 104 out of the transport plane during drying results in the edge 104c contacting the entry 114b, more specifically the upper transport roller 106a. This curl can be easily handled, as after having held the sheet 104 for the desired time until the print material has dried, the sheet 104 can be moved by the roller pair 106a and 106b into the path of the duplexer 114 without any danger of jamming as the amount of movement or curl of the edge 104c is limited. FIG. 6B shows a further way the lower or trailing edge of the sheet may curl. The curl may be such that a portion of the sheet away from the lower edge raises above the transport plane. Since the trailing edge is contained by the roller pair it will remain substantially in the transport plane so that after drying the sheet can be fed by the rollers without any jam. If the sheet 104 had been stopped at a position having a larger distance between the edge 104c and the roller pair 106a, 106b, this would have resulted in a curl or movement of the edge 104c out of the transport plane as shown in FIG. 7. Moving the sheet 104 in the direction towards the roller pair 106a and 106b would have caused a jam. This is avoided since the sheet 104 is positioned with its trailing edge 104c in a location such that the trailing edge is contained by the two rollers without being pinched there between.

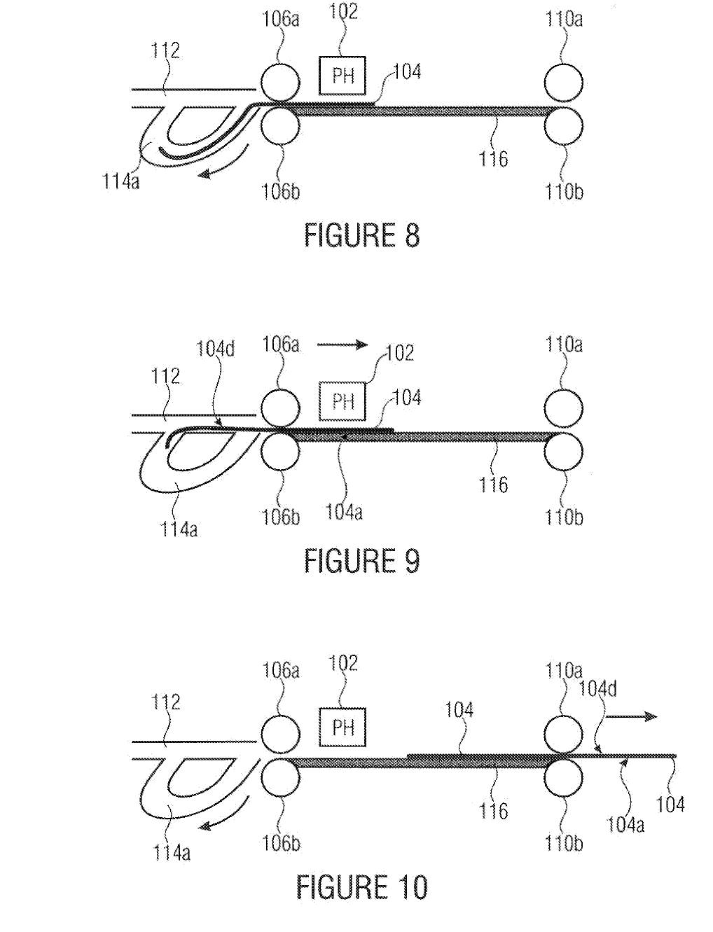

The sheet 104 is held or maintained in the position shown in FIG. 5 until the ink has dried. After that, the sheet 104 is moved into the duplexer path 114a as shown in FIG. 8 and fed back to the printhead 102 as shown in FIG. 9 also printing the second side 104d not yet printed. After printing of both sides 104a and 104d has been completed, the sheet 104 is output as shown in FIG. 10.

In the example described above with regard to FIGS. 1 to 10 the entire length of the sheet 104 was printed. However, the described approach is equally applicable to printing the bottom or the trailing edge of the sheet 104, irrespective as to whether also the rest of the sheet is printed or not. The principles described are also applicable to approaches where duplex printing is desired and printing the medium 104 occurs within a print area on the sheet 104 with margins, for example at the trailing edge. Also in such situations, for printing the lower part or the trailing part of the sheet 104 the trailing edge leaves the nip between the rollers 106a, 106b. After printing the sheet will be positioned as shown in FIG. 5 to avoid a possible jam that might occur due to curling of the sheet while drying.

While the examples described with regard to FIGS. 1 to 10 show the duplexer downstream of the printhead 102, it is noted that the duplexer entry may also be upstream of the printhead 102.

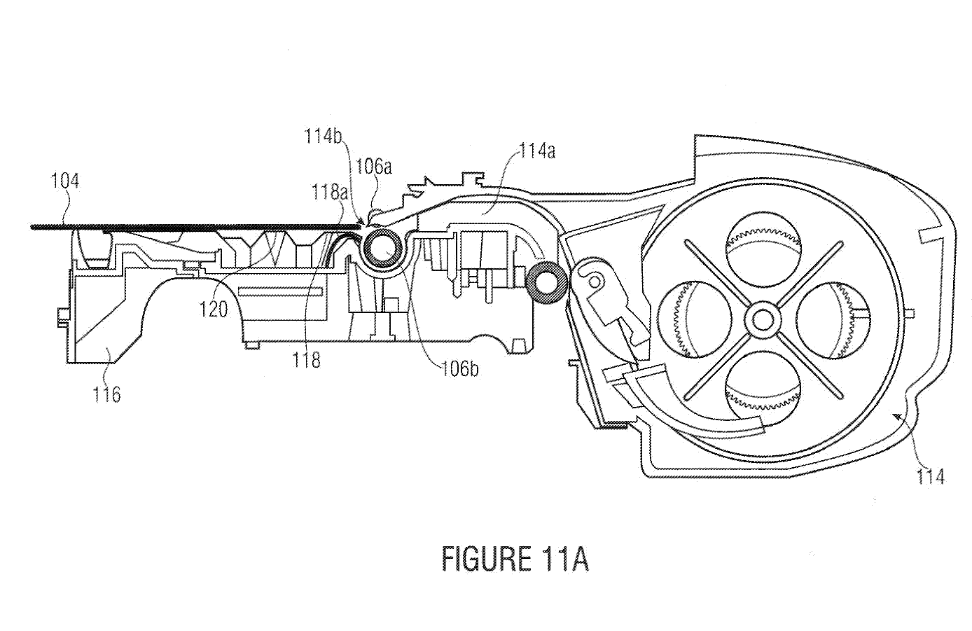

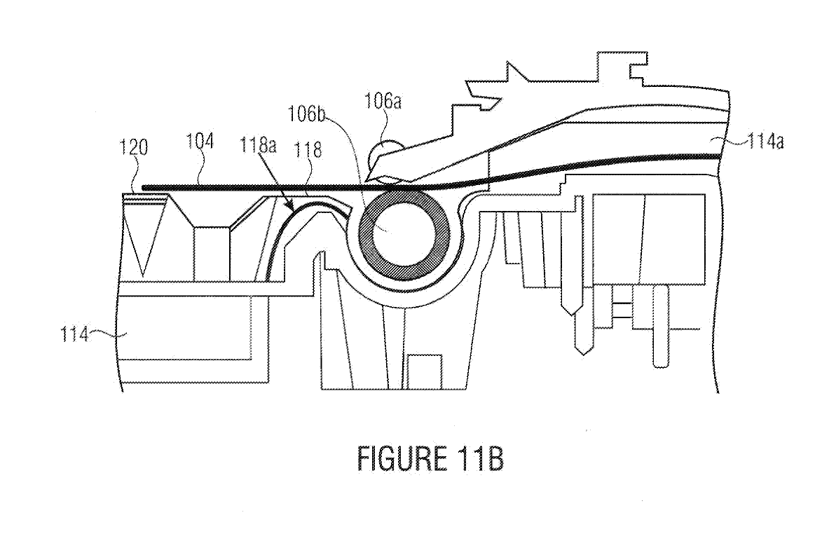

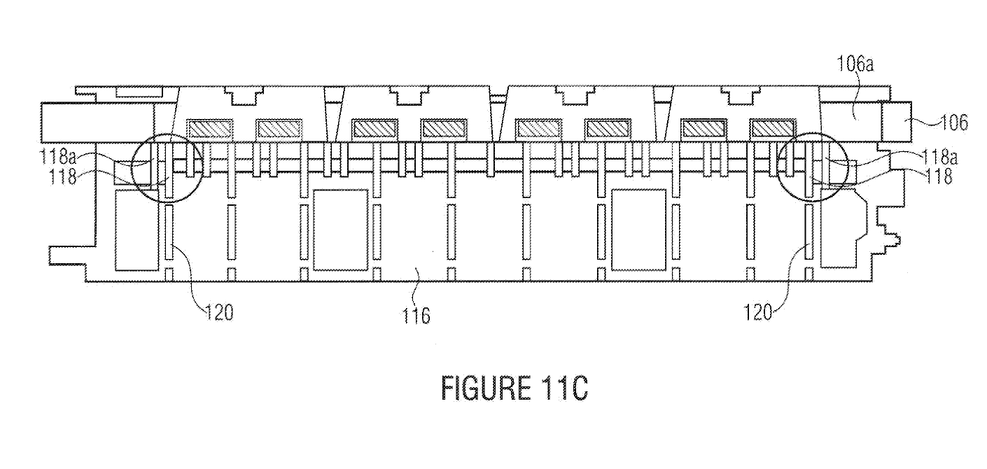

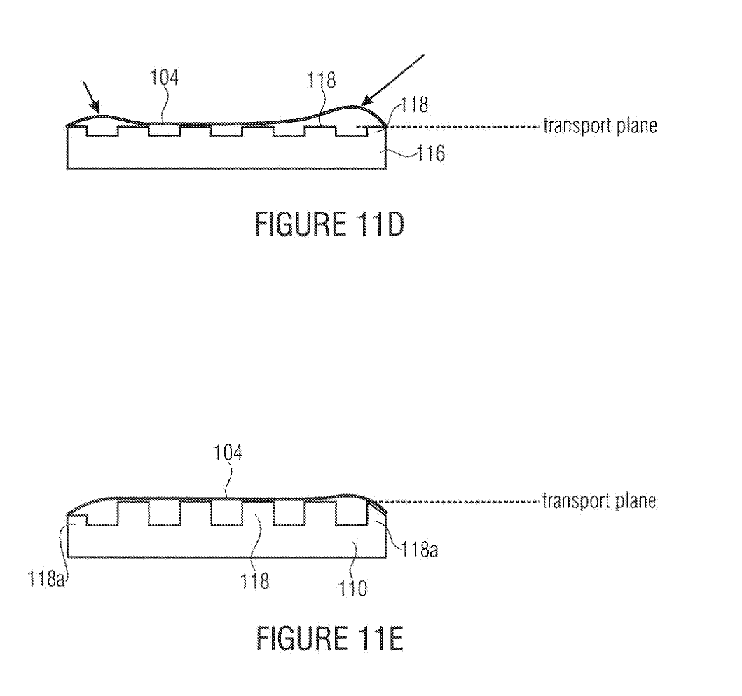

FIG. 11(a) is a schematic representation of a part of the paper path of a printer in accordance with another example. In FIG. 11(a) the sheet 104 has been reversed after printing and is at a position as shown also in FIG. 5 at the entry 114b of the duplexer 114 (see the right hand side of FIG. 11(a)). The entry of the duplexer 114 comprises the two transport elements 106a and 106b of which element 106b is a driven element whereas element 106a is formed by an idler roller biased against the roller 106a. The platen 116 comprises a plurality of ribs 118, 120 on which the sheet 104 rests while being transported. The upper surfaces of the ribs 118 and 120 define a transport plane in which the sheet 104 is moved. In accordance with an embodiment, a plurality of ribs are provided in the width direction of the sheet 104 with the outermost set of ribs 118a being lowered or angled with regard to the other ribs 118 which allows to accommodate sheet curl at the edges and thereby improves the reliability upon feeding the sheet 104 to the entry 114b of the duplexer 114. FIG. 11(b) is an enlarged side view of the duplexer entry 114 showing the lowered or angled outer ribs 118a in further detail. FIG. 11(c) shows a top view of the platen 116 where the position of the lowered/angled outermost ribs 118a is indicated with respect to the inner ribs. As can be seen, the ribs close to the rollers 106a, 106b are provided with the lowered/angled outermost ribs 118a. FIG. 11(d) shows a platen structure 116 having the ribs 118 all at the same level defining the transport plane. A sheet 104 is on the platen 116 and curl may occur at its side edges. When the side edges curl, due to this curl a part of the sheet close to the side edges raises from the platen above the transport plane (see the positions indicated by the arrows). This results in a possible jam as the sheet cannot be properly received by the nip between the transport rollers 106a, 106b, rather the portions indicated by the arrows, upon feeding the sheet towards the nip may abut against the roller. FIG. 11(e) show the platen structure according to an embodiment. As described above, the outer ribs 118a may be angled (see the right part of FIG. 11(e)) or may be lower (see the left part of FIG. 11(e)) when compared to the inner ribs 118. The lower ribs are below the transport plane. The angled ribs have an upper surface extending from the transport plane below the transport plane. This structure allows to compensate for a curl at the side edges of the sheet 104. When a curl occurs the side edges can move downward as is shown in FIG. 11(e) so that no part of the sheet raises above the transport plane. The sheet can be securely fed into the nip of the roller pair 106a, 106b. It is noted that other embodiments may use a platen having a planar surface, wherein a side edge of the platen has a step or is inclined to extend below the transport plane defined by the planar surface. The same effect as described above is achieved with this structure.

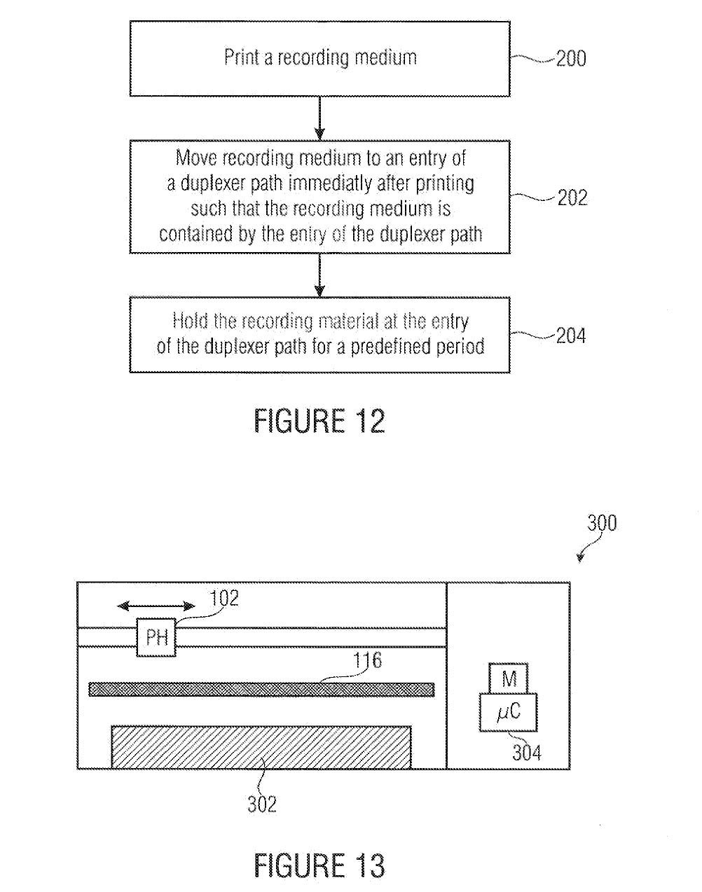

FIG. 12 is a flow diagram of a method for printing. In step 200 a recording medium is printed. In step 202 the recording medium is moved to an entry of a duplexer path immediately after printing a first side of the recording medium such that the recording medium is contained by the entry of the duplexer path. The recording medium 204 is held at the entry of the duplexer path before printing a second side of the recording medium (step 204). In accordance with embodiments, a computer program product may be provided comprising a program stored by a computer readable medium and comprising instructions for executing the above-mentioned method.

FIG. 13 shows an example of a printer 300 having the printhead 102, the platen 116 and a magazine 302 for providing a recording medium to a print zone defined between the printhead 102 and the platen 116. The printer 300 includes a duplexer that was described above and which is not shown in FIG. 13, and a controller 304. The printer 300 may comprise a memory M for storing computer readable instructions, e.g. firmware, for the printer for allowing the controller 304 to control the operation of the printer on the basis of the firmware. The above described program may be stored as a part of the firmware in this memory M.

In the examples described above the transport at the entry of the duplexer included a roller pair 106a and 106b. The roller pair may be formed by a pair of driven rollers or one of the rollers is driven whereas the other roller is an idle roller. Also, it is possible to realize the transport 106a, 106b in a different way, for example by providing a single roller either the roller 106a or the roller 106b and replacing the other roller by other appropriate guide elements, such as guiding paddles.

A printer in accordance with embodiments may be the above described ink jet printer, however, the above principles may be also applied to electro photographic printers using a toner as a recording medium.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed. Some examples comprise a data carrier having electronically readable control signals, which are capable of cooperating with a programmable computer system, such that a method described herein is performed. Generally, examples can be implemented as a computer program product with a program code, the program code being operative for performing a method when the computer program product runs on a computer. The program code may for example be stored on a machine readable carrier.

The above described embodiments are merely illustrative for the principles. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

What is claimed is:

1. A printer, comprising:
a printing device configured to print a recording medium; and
a transport configured to
move the recording medium to an entry of a duplexer path immediately after printing a first side of the recording medium such that an edge of the recording medium is contained by the entry of the duplexer path, and
hold the recording medium at the entry of the duplexer path before printing a second side of the recording medium.

2. The printer of claim 1, wherein for moving the recording medium to the entry of the duplexer path immediately after printing the transport is configured to move the recording medium to the entry of the duplexer path
after printing the first side of the recording medium is completed and prior to a print material on the recording medium having dried, or
after a last swath of a print material was applied to the recording medium.

3. The printer of claim 1, wherein the transport is configured to move the recording medium such that an edge of the recording medium is at a position close to the entry of the duplexer path, wherein in case of a movement of the edge of the recording medium out of a transport plane during drying of a print material applied to the recording medium, the edge of the recording medium contacts the entry of the duplexer path.

4. The printer of claim 1, wherein
the entry of the duplexer path comprises a first transport configured to contact the first side of the recording medium, and a second transport configured to contact the second side of the recording medium, the first and second transports defining a feed pinch, and
the transport is configured to move the recording medium such that an edge of the recording medium is contained by the first and second transports without being pinched there between.

5. The printer of claim 4, wherein one of the first and second transports comprises a driven transport.

6. The printer of claim 1, wherein
the transport is configured to move the recording medium along the duplexer path, after a period of time has elapsed, and
the printing device is configured to print the second side of the recording medium.

7. The printer of claim 1, wherein the printer is configured to print an edge of the recording medium.

8. The printer of claim 7, wherein the printer is configured to print a leading edge or a trailing edge, or both, of the recording medium.

9. The printer of claim 1, wherein the printing device is configured to print an entire length of the sheet.

10. The printer of claim 1, wherein
the transport comprises a platen having a planar surface, wherein a side edge of the platen has a step or is inclined to extend below the transport plane defined by the planar surface, or
the transport comprises a plurality of ribs configured to support the recording medium in a transport plane, wherein outer ribs are lowered or angled to extend below the transport plane defined by inner ribs.

11. The printer of claim 1, wherein the printing device comprises an ink jet printing device or an electro photographic printing device.

12. An ink jet printer, comprising:
a feed mechanism;
an ink jet printhead;
a duplexer comprising an entry including a first transport and a second transport, the first and second transports defining a feed pinch; and
a controller,
wherein the controller is configured to
control the ink jet printhead and the feed mechanism to print a trailing edge of a first side of a recording medium, and
control the feed mechanism to reverse the printed recording medium immediately after printing such that the trailing edge is contained by the first and second transports of the duplexer without being pinched there between, and to hold the recording medium at this position.

13. The ink jet printer of claim 12, wherein the controller is further configured to
control the feed mechanism and the duplexer such that the printed recording medium is moved through the duplexer after a period of time has elapsed,
control the ink jet printhead to print a second side of the recording medium, and
control the feed transport to output the duplex printed recording medium.

14. A computer program product comprising a program stored by a computer readable medium, the program comprising instructions for executing a method when running on a computer, the method comprising:
printing a recording medium;
moving the recording medium to an entry of a duplexer path immediately after printing a first side of the recording medium such that an edge of the recording medium is contained by an entry of the duplexer path; and
holding the recording medium at the entry of the duplexer path before printing a second side of the recording medium.

15. The computer program product of claim 14, wherein the program is stored as a part of a firmware of a printer, the printer comprising a controller operating on the basis of the firmware.
